(19) United States
(12) Patent Application Publication
(10) Pub. No.: US 2019/0042743 A1
(43) Pub. Date: Feb. 7, 2019

(54) MALWARE DETECTION AND CLASSIFICATION USING ARTIFICIAL NEURAL NETWORK

(71) Applicant: Intel Corporation, Santa Clara, CA (US)

(72) Inventor: Li Chen, Hillsboro, OR (US)

(21) Appl. No.: 15/843,900

(22) Filed: Dec. 15, 2017

(51) Int. Cl. G06F 21/56; G06N 3/04; G06F 15/18

(52) U.S. Cl. CPC G06F 21/563; G06F 15/18; G06N 3/0454

(57) ABSTRACT

An apparatus for computing is presented. In embodiments, the apparatus may include a converter to receive and convert a binary file into a multi-dimensional array, the binary file to be executed on the apparatus or another apparatus. The apparatus may further include an analyzer coupled to the converter, the analyzer to process the multi-dimensional array to detect and classify malware embedded within the multi-dimensional array using at least one partially retrained artificial neural network having an input layer, an output layer and a plurality of hidden layers between the input and output layers. The analyzer may further output a classification result, and the classification result may be is used to prevent execution of the binary file on the apparatus or on another apparatus.

### FIELD

Embodiments of the present disclosure relate to the technical field of computing, and in particular to malware detection and classification.

### BACKGROUND

Conventional computing systems may include automated malware detection systems. Some malware detection systems may be powered by machine learning algorithms use signatures to achieve high classification results. However, the rapid increase of signatures, which is approaching exponential, makes signature matching machine learning difficult or unable to keep up. Other approaches include static and dynamic analysis, both of which have advantages and disadvantages. While static analysis can disassemble code being analyzed, its performance can suffer from code obfuscation. On the other hand, dynamic analysis, which is able to unpack unknown or suspicious code, can be time consuming. Moreover, in datasets having a large number of dimensions, if dimension reduction is implemented without full knowledge of the data, classification results may degrade significantly.

### BRIEF DESCRIPTION OF THE DRAWINGS

FIG. 1 illustrates an overview of a system having malware detection and classification technology of the present disclosure, in accordance with various embodiments.

FIG. 1A illustrates a training system overview, in accordance with various embodiments.

FIG. 2 illustrates an alternate system overview, depicting an “ensemble” system, in accordance with various embodiments.

FIG. 3 illustrates use of transfer learning, in accordance with various embodiments.

FIGS. 4A through 4L illustrate an example partially retrained deep neural network classifier, in accordance with various embodiments.

FIG. 5 illustrates an overview of the operational flow of a process for detecting and classifying malware in accordance with various embodiments.

FIG. 6 illustrates an overview of the operational flow of an alternate process for detecting and classifying malware, using an ensemble of two artificial neural networks, in accordance with various embodiments.

FIG. 7 illustrates an overview of the operational flow of a process for training and validating a malware detection and classification system, in accordance with various embodiments.

FIG. 8 illustrates a block diagram of a computer device suitable for practicing the present disclosure, in accordance with various embodiments.

FIG. 9 illustrates an example computer-readable storage medium having instructions configured to practice aspects of the processes of FIGS. 5-7, in accordance with various embodiments.

### DETAILED DESCRIPTION

In embodiments, an apparatus for computing may include a converter to receive and convert a binary file into a multi-dimensional array, the binary file to be executed on the apparatus or another apparatus, and an analyzer coupled to the converter to process the multi-dimensional array to detect and classify malware embedded within the multi-dimensional array. In embodiments, the converter may use at least one partially retrained artificial neural network having an input layer, an output layer and a plurality of hidden layers between the input and output layers. In embodiments, the converter may further output a classification result, where the classification result is used to prevent execution of the binary file on the apparatus or another apparatus.

In embodiments, the multi-dimensional array may be a 2D array. In embodiments, the converter may first convert the binary file to a vector of 8-bit unsigned integers, and may then convert the vector to the 2D array. Further, in some embodiments, the converter may first convert the vector to an internal 2D array, and then resize the internal 2D array prior to the outputting the 2D array. In such embodiments, the resized 2D array may have a size of, for example, 224 by 224, or 299 by 299. In alternate embodiments, where the converter outputs two 2D arrays, to be respectively analyzed by two artificial neural networks, the resized arrays may have a first 2D array of, for example, 224 by 224, or 299 by 299, and a second 2D array of, for example, 28 by 28.

In embodiments, the at least one partially retrained artificial neural network may include a neural network previously trained to recognize patterns, with the weights of a number of its initial layers frozen, and the weights of a number of its last layers retrained to recognize malware binaries. For example, the artificial neural network may include the Inception-BN network, with its last layer retrained to classify malware. Or, for example, in embodiments, the artificial neural network may be one of Visual Geometry Group (VGG) 16 or VGG 19, with its top layers frozen and its last three layers retrained to classify malware.

In embodiments, the apparatus may comprise a malware detector including the converter and the analyzer, or, for example, may include an operating system having the converter and the analyzer. In embodiments, the apparatus may be a cloud server.

In the description to follow, reference is made to the accompanying drawings which form a part hereof wherein like numerals (or, as the case may be, the last two digits of an index numeral) designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Operations of various methods may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiments. Various additional operations may be performed and/or described operations may be omitted, split or combined in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

Also, it is noted that embodiments may be described as a process depicted as a flowchart, a flow diagram, a dataflow diagram, a structure diagram, or a block diagram. Although a flowchart may describe the operations as a sequential process, many of the operations may be performed in parallel, concurrently, or simultaneously. In addition, the order of the operations may be re-arranged. A process may be terminated when its operations are completed, but may also have additional steps not included in the figure(s). A process may correspond to a method, a function, a procedure, a subroutine, a subprogram, and the like. When a process corresponds to a function, its termination may correspond to a return of the function to the calling function and/or the main function. Furthermore, a process may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium. A code segment may represent a procedure, a function, a subprogram, a program, a routine, a subroutine, a module, program code, a software package, a class, or any combination of instructions, data structures, program statements, and the like.

As used hereinafter, including the claims, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may implement, or functions associated with the circuitry may be implemented by, one or more software or firmware modules.

As used hereinafter, including the claims, the term “memory” may represent one or more hardware devices for storing data, including random access memory (RAM), magnetic RAM, core memory, read only memory (ROM), magnetic disk storage mediums, optical storage mediums, flash memory devices and/or other machine readable mediums for storing data. The term “computer-readable medium” may include, but is not limited to, memory, portable or fixed storage devices, optical storage devices, wireless channels, and various other mediums capable of storing, containing or carrying instruction(s) and/or data.

As used hereinafter, including the claims, the term “computing platform” may be considered synonymous to, and may hereafter be occasionally referred to, as a computer device, computing device, client device or client, mobile, mobile unit, mobile terminal, mobile station, mobile user, mobile equipment, user equipment (UE), user terminal, machine-type communication (MTC) device, machine-to-machine (M2M) device, M2M equipment (M2ME), Internet of Things (IoT) device, subscriber, user, receiver, etc., and may describe any physical hardware device capable of sequentially and automatically carrying out a sequence of arithmetic or logical operations, equipped to record/store data on a machine readable medium, and transmit and receive data from one or more other devices in a communications network. Furthermore, the term “computing platform” may include any type of electronic device, such as a cellular phone or smartphone, a tablet personal computer, a wearable computing device, an autonomous sensor, personal digital assistants (PDAs), a laptop computer, a desktop personal computer, a video game console, a digital media player, an in-vehicle infotainment (IVI) and/or an in-car entertainment (ICE) device, an in-vehicle computing system, a navigation system, an autonomous driving system, a vehicle-to-vehicle (V2V) communication system, a vehicle-to-everything (V2X) communication system, a handheld messaging device, a personal data assistant, an electronic book reader, an augmented reality device, and/or any other like electronic device.

As used hereinafter, including the claims, the term “link” or “communications link” may refer to any transmission medium, either tangible or intangible, which is used to communicate data or a data stream. Additionally, the term “link” may be synonymous with and/or equivalent to “communications channel,” “data communications channel,” “transmission channel,” “data transmission channel,” “access channel,” “data access channel,” “channel,” “data link,” “radio link,” “carrier,” “radiofrequency carrier,” and/or any other like term denoting a pathway or medium through which data is communicated.

As used hereinafter, including the claims, the terms “module”, “input interface”, “converter”, “analyzer”, “artificial neural network”, “trained neural network”, “partially retrained artificial neural network”, or “retrained artificial neural network” may refer to, be part of, or include one or more Application Specific Integrated Circuits (ASIC), electronic circuits, programmable combinational logic circuits (such as field programmable gate arrays (FPGA)) programmed with logic to perform operations described herein, a processor (shared, dedicated, or group) and/or memory (shared, dedicated, or group) that execute one or more software or firmware programs generated from a plurality of programming instructions with logic to perform operations described herein, and/or other suitable components that provide the described functionality.

In what follows, a malware detection system that utilizes transfer learning is described. It is initially noted that artificial neural networks (ANNs) may be quite expensive to train. For example, highly complex models may take weeks to train, using hundreds of machines, each equipped with expensive Graphics Processing Units (GPUs). Thus, in embodiments, using transfer learning, an example apparatus may transfer as much knowledge as possible from a complex artificial neural network and apply that knowledge to a relatively smaller size dataset, such as, for example, malware binaries. As a result, as described below, in embodiments, a complex artificial neural network already trained on a large dataset may be partially trained on malware binaries in a short time. Furthermore, as also noted below, apparatus according to various embodiments are robust to code obfuscation.

In embodiments, limited malware training data may be used to establish effective classification results. For example, a source setting may include textual information learned from 1.5 million images, which may then be applied to a target task of malware image classification. Thus, an ANN which was trained on the 1.5 million images need only be slightly retrained on a malware dataset to be able to accurately classify images as containing malware.

It is noted that various embodiments described herein may be said to transform a malware detection problem into a visual recognition problem. Thus, in embodiments, the effort and cost to extract malware features may be significantly reduced. It is also here noted that while conventional malware detection methods may require one or more of analyzing code, matching signatures, and counting histograms and loops, in embodiments, malware binaries converted to images may be quickly scanned and classified without requiring feature extraction or similar efforts. Thus, in accordance with various embodiments, visualization may be performed by an apparatus to examine the texture of malware binaries.

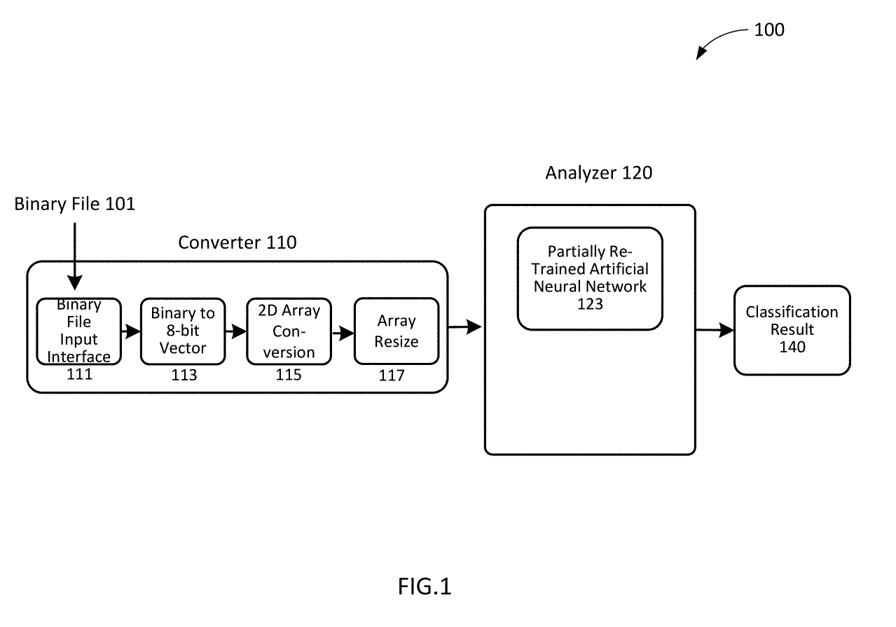

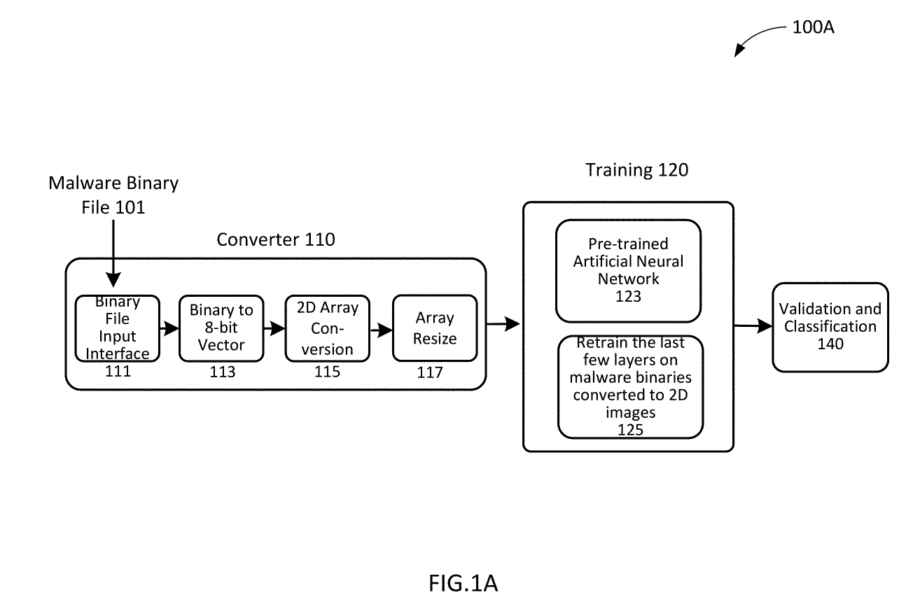

FIG. 1 illustrates an overview of a system 100 incorporated with the malware detection and classification technology of the present disclosure, in accordance with various embodiments. System 100 may include an apparatus including converter 110 and analyzer 120. Converter 110 and analyzer 120 may each be separate chips or modules, or for example, may be integrated into a single chip or module. With reference to FIG. 1, a binary file 101 may be input to converter 110. The binary file may include audio data, textual data, image data, or the like. In general, binary file 101 is not known to be secure, and may contain malware, which is why it is desirable to scan it and classify it before allowing it to be executed on an apparatus, e.g., an apparatus having system 100 or any other apparatus that may be notified by system 100 of the classification result. If, after analysis, it is classified as being a type of malware, in embodiments, the classification result may be used to prevent execution of the binary file on an apparatus having system 100 or another apparatus that may be notified by system 100 of the classification result.

In embodiments, converter 110 may receive binary file 101 via binary file input interface 111, and may perform several pre-processing techniques. In embodiments, these techniques may include converting the binary file to a vector, such as, for example, a vector of 8-bit unsigned integers. In embodiments, this may be performed by binary to 8-bit vector conversion 113. Following conversion, the vector may be converted into a multidimensional array, such as, for example, a 2D array, as illustrated in the example apparatus of FIG. 1, by 2D array conversion 115. For example, the 1D 8-bit vector may be converted into a 2D array whose size depends upon the length of the 1D vector. For example, 2D array conversion may set a width and height of the 2D array according to the following table, where the height of the 2D array is the total length divided by the width:

TABLE 1
2D Array Width/Height

| Length (bytes) | Width | Height |
|---|---|---|
| <=1000 | 512 | Length/512 |
| >1000 to 1500 | 1024 | Length/1024 |
| >1500 | 2048 | Length/2048 |

In embodiments, the 2D array generated by 2D Array conversion 115, may be further resized to accommodate an input size required by an ANN to be used to process it. Thus, for example, considering some well-known convolutional artificial neural networks, Visual Geometry Group (VGG) 16, VGG19, Inception-BN, AlexNet and ResNet all accept 224×224 input images, while Inception v3 and Xception require 299×299 pixel inputs. On the other hand, LeNet has an input size of 28×28. Thus, in embodiments, the last module shown in converter 110, i.e., array resize 117, may resize the 2D array created by 2D array conversion 115 to one or more resized 2D arrays. Because a 2D array of data, especially a 2D array including 8-bit unsigned integers, may be thought of as an image, where each element describes a greyscale value between 0 and 255, such a 2D array may be referred to herein as “a 2D image.”

It is here reiterated that a 2D array is only one example of a multidimensional array that may be used in various embodiments, and is thus non-limiting. It is thus understood that for other multidimensional arrays, in embodiments, each of array conversion 115 and array resize 117 modules of converter 110 as shown in FIG. 1 may generate and resize arrays of various dimensions.

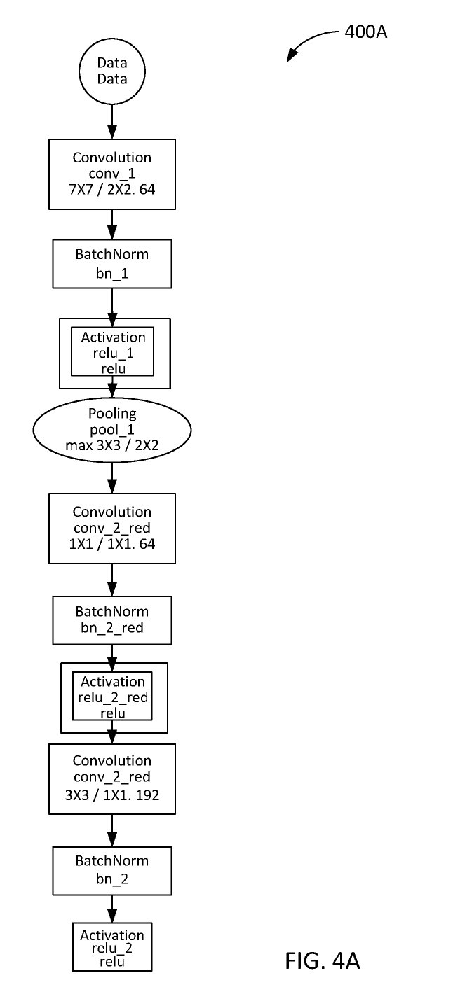

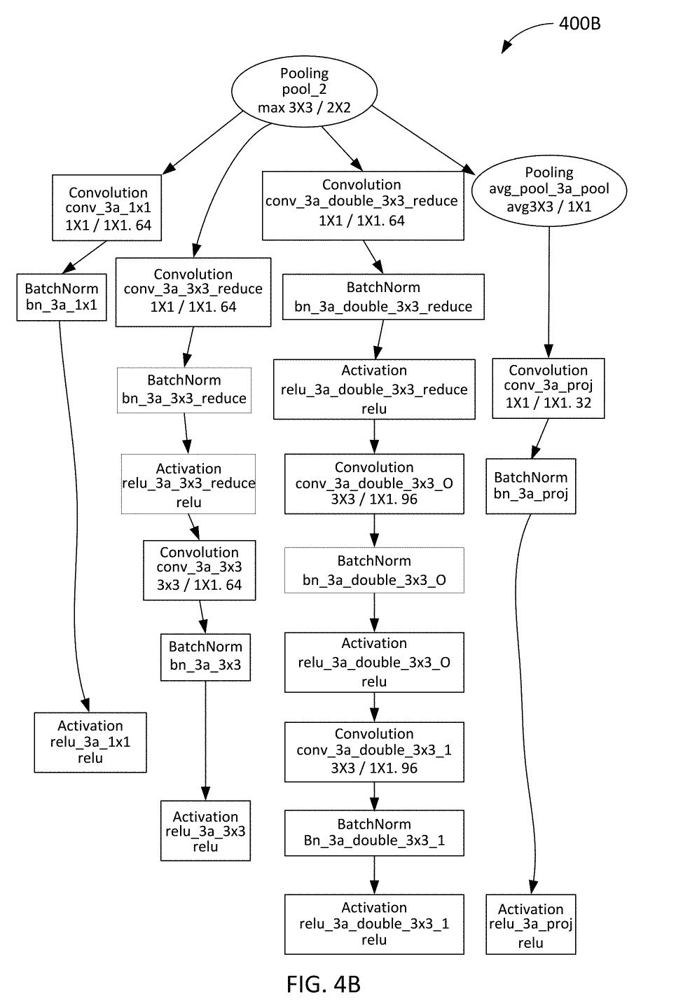

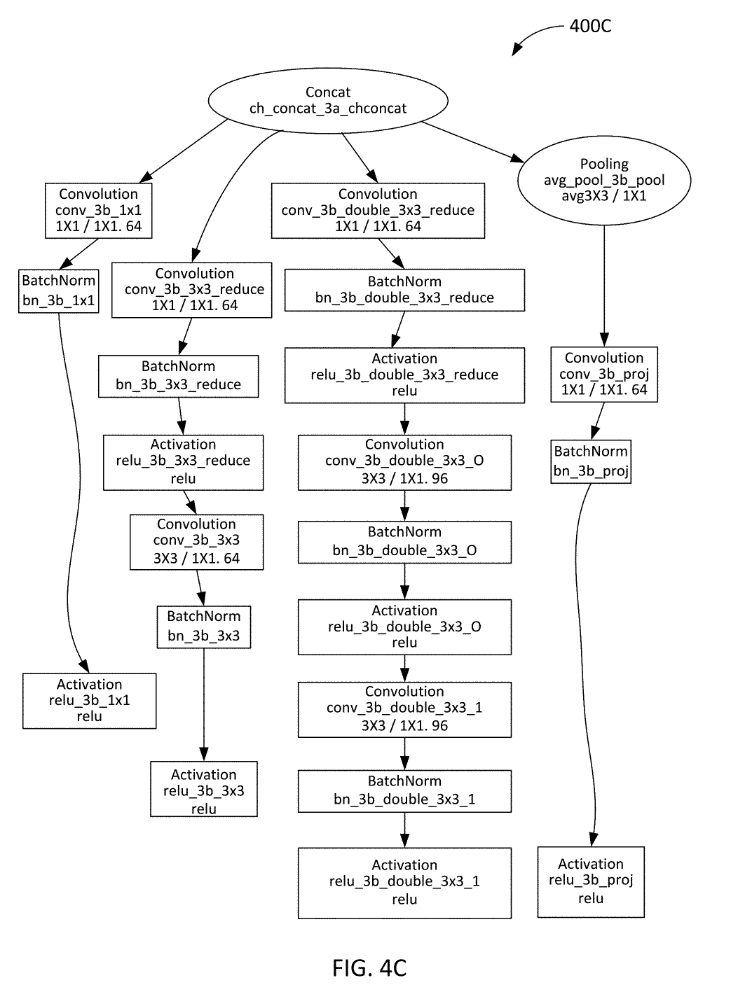

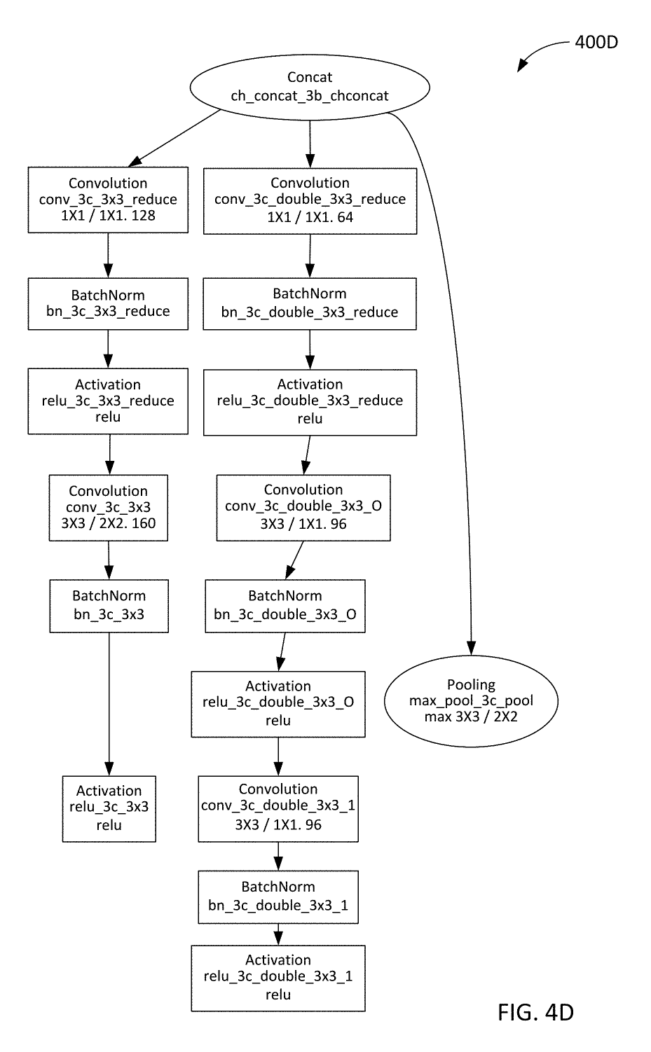

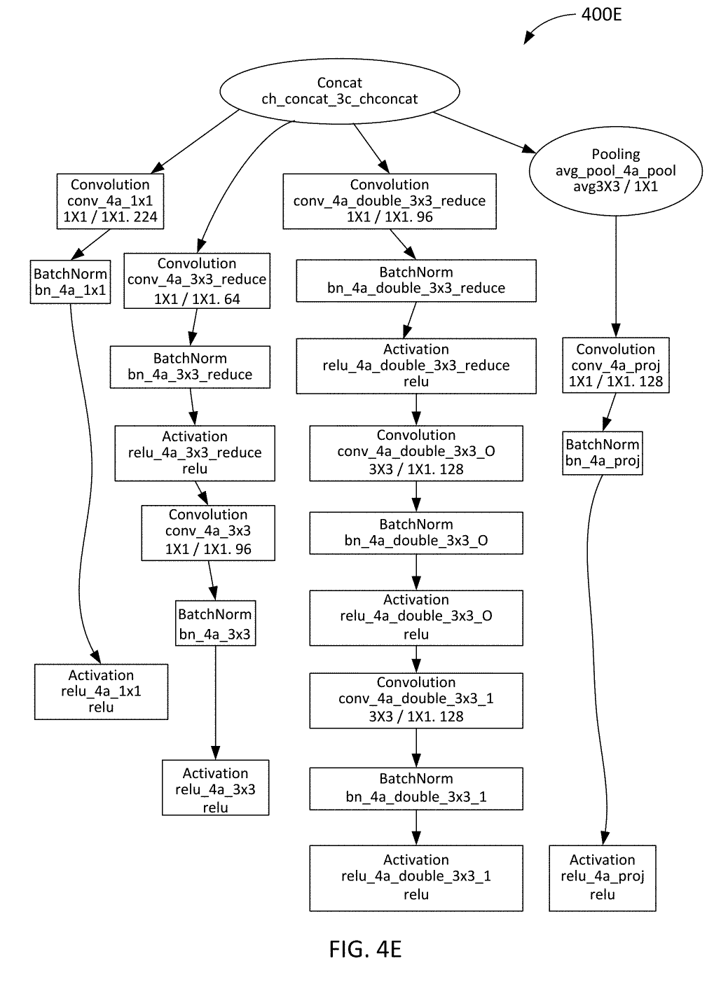

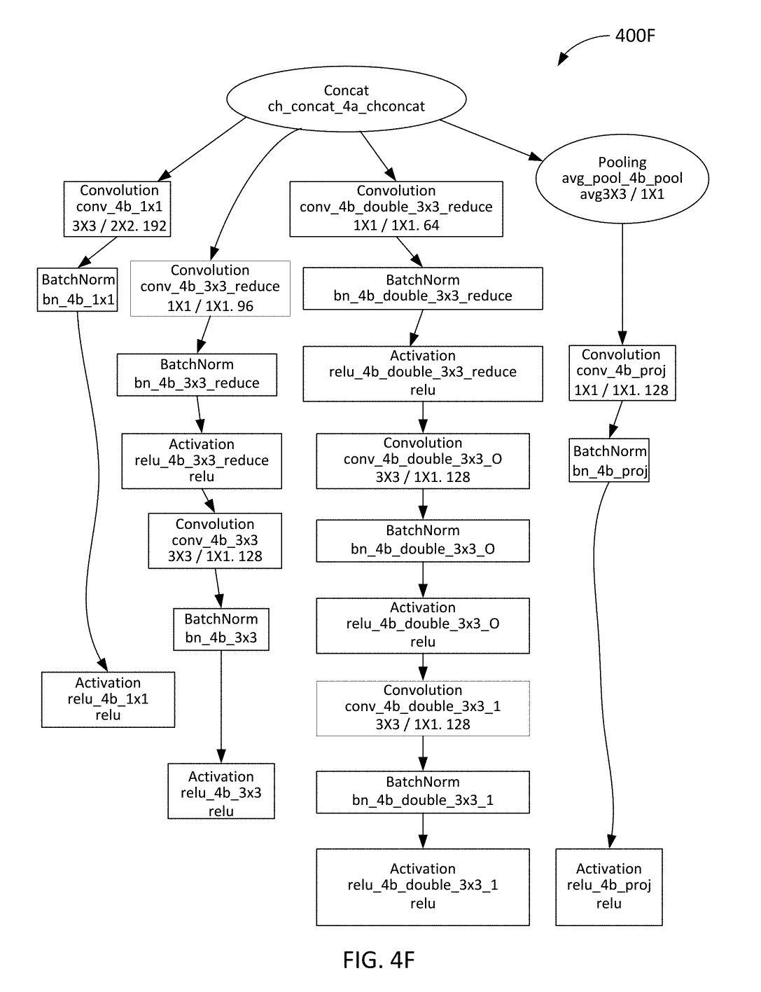

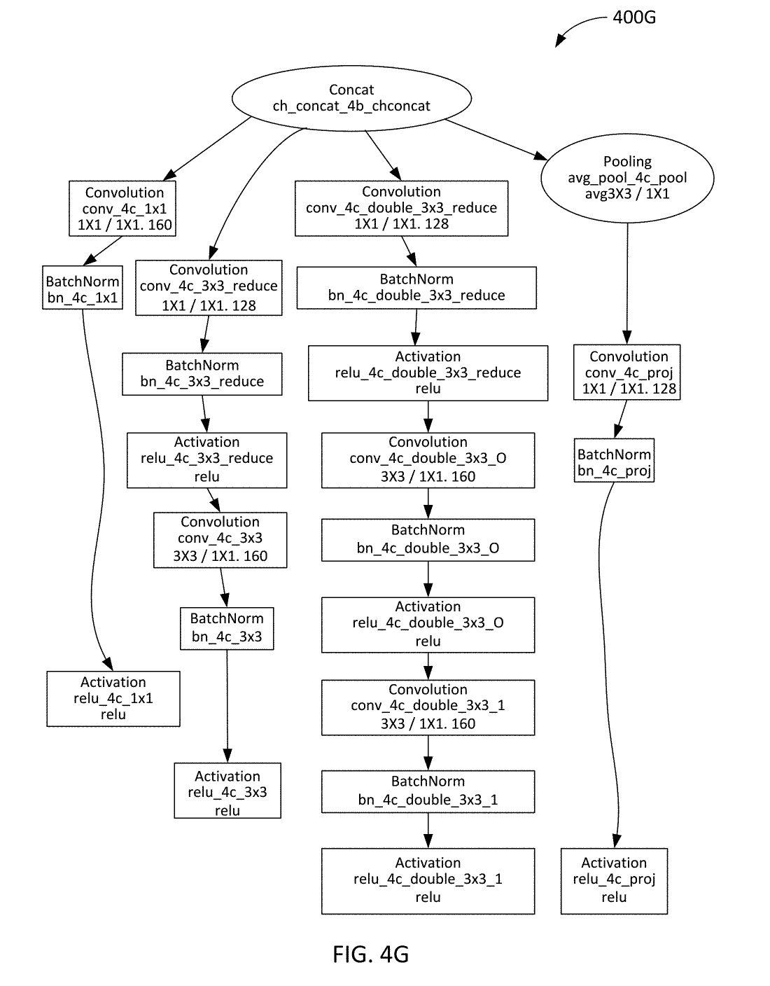

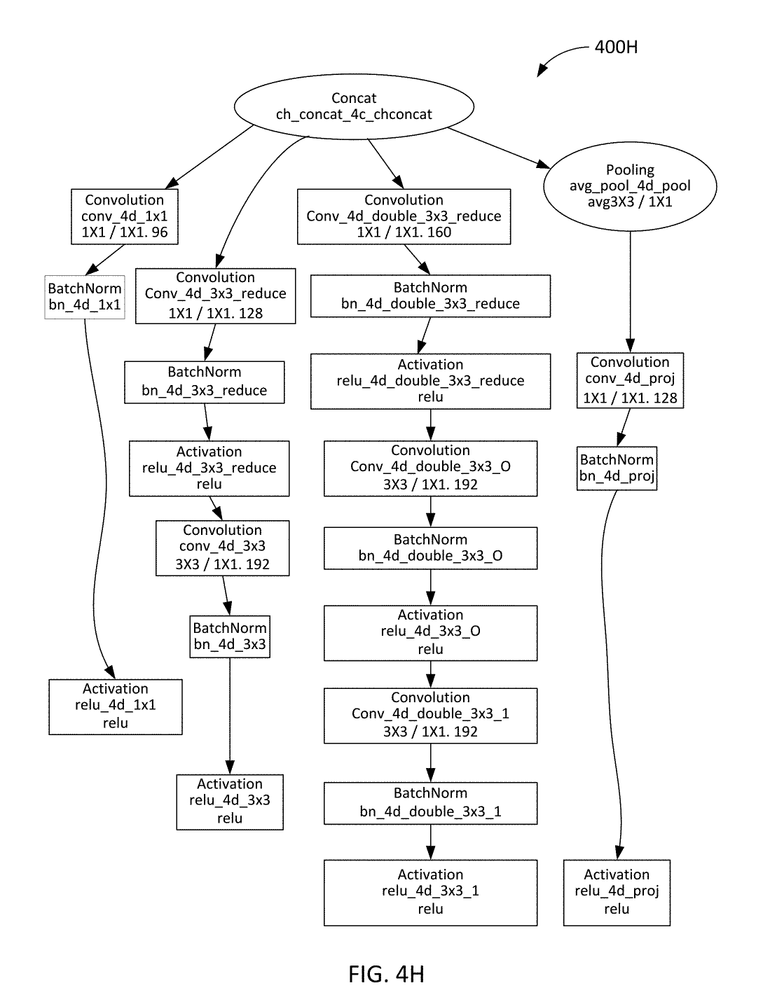

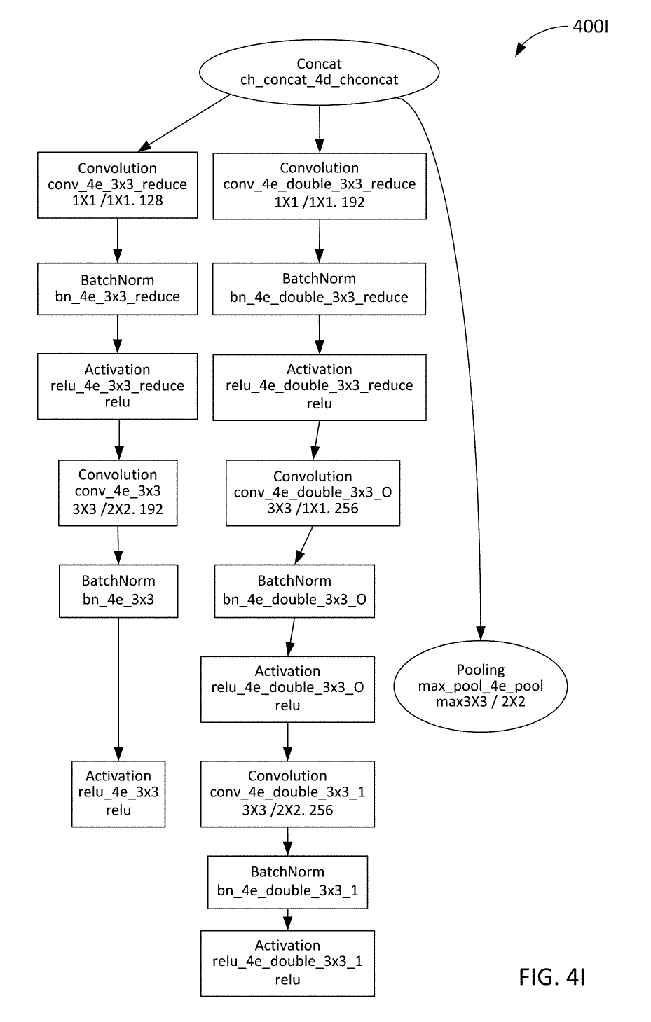

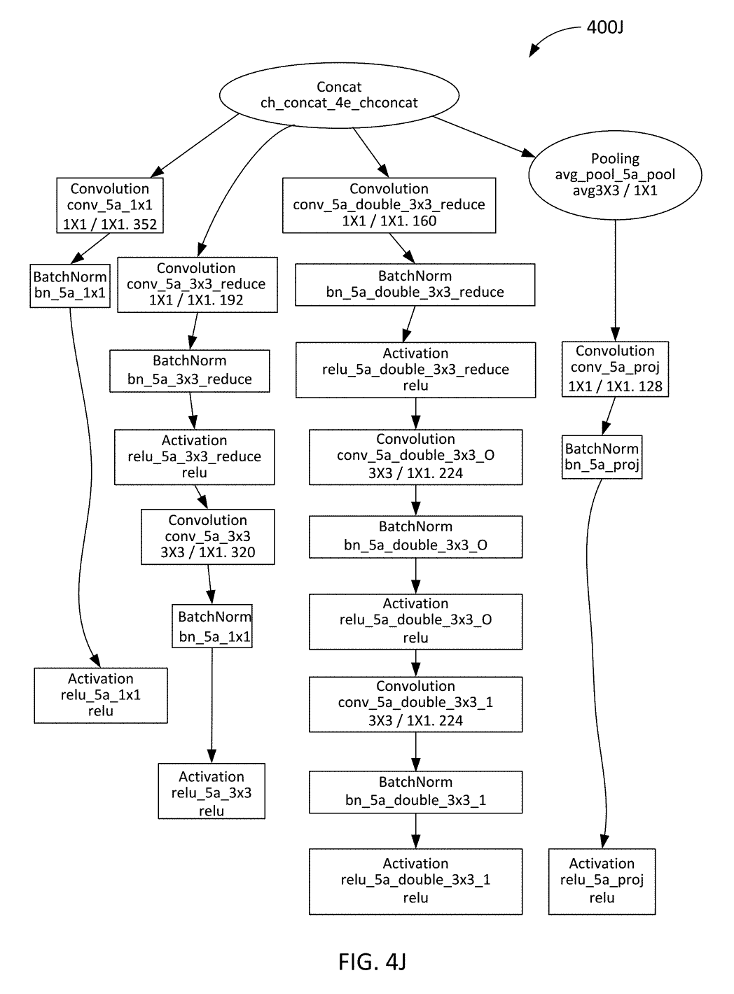

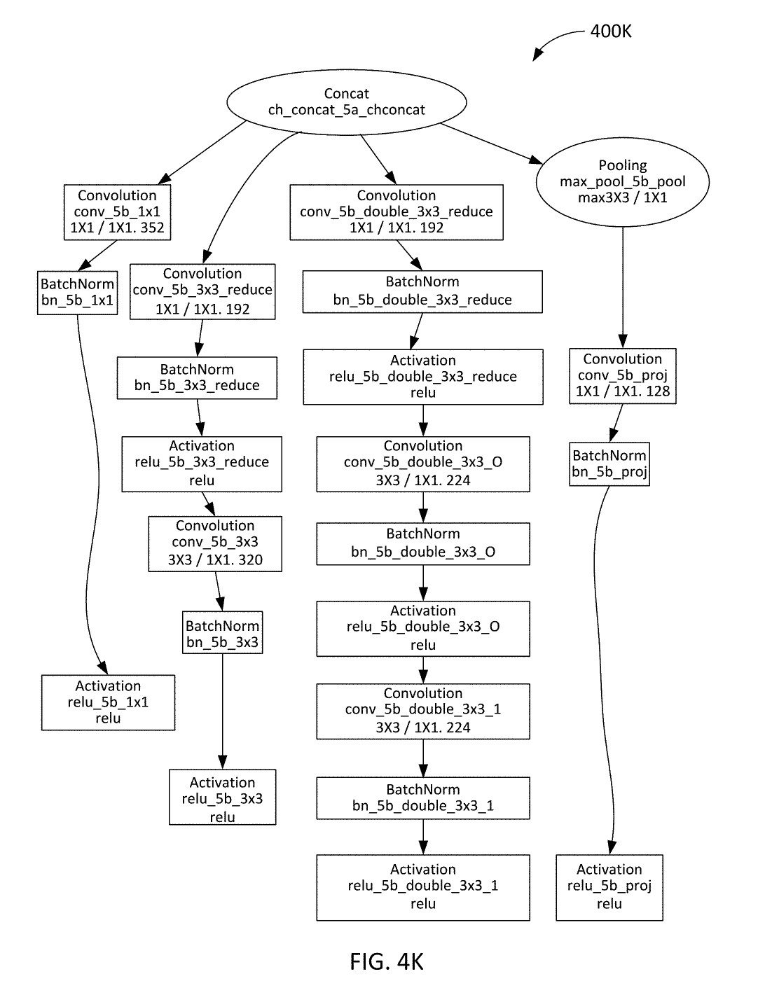

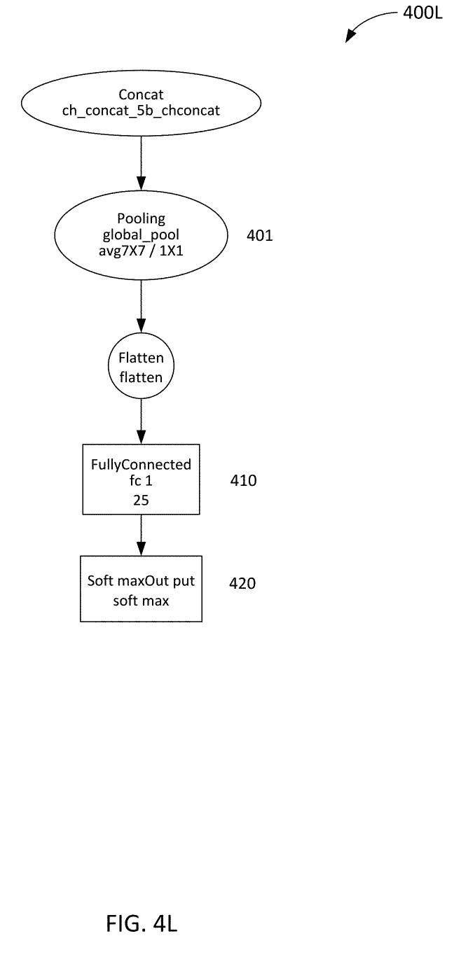

Continuing with reference to FIG. 1, in embodiments, a resized 2D array output from array resize 117 may be input to analyzer 120. Analyzer 120 may include a partially retrained ANN 123 having an input layer, an output layer and a plurality of hidden layers between the input and output layers, for example, a convolutional neural network such as Inception-BN. An example partially retrained version of Inception-BN is illustrated in FIGS. 4A through 4L, described below. It is here noted that ANN 123 may be referred as a deep neural network, and further, leveraging transfer learning, as described above, may be utilized in accordance with various embodiments. Thus, in embodiments, the first several layers of an ANN may be frozen, and its weights obtained from existing state-of-the-art neural network models. In embodiments, this information may be obtained from domains such as, for example, natural image classification or computer vision. Then, the rest of the layers of the ANN, i.e., those not frozen, may be tuned and trained on domain-specific data, such as, in accordance with various embodiments, malware images, obtaining a partially retrained ANN 123. This retraining process is describe more fully below, with reference to FIG. 1A.

Finally, after processing the resized 2D array with partially retrained ANN 123, a classification result 140 may be obtained. In embodiments, if classification result 140 is a type of malware, then classification result 140 may be used to prevent execution of binary file 101 on an apparatus having system 100 or another apparatus that may be notified by system 100 of the classification result.

In embodiments, system 100 may be implemented as a malware detector having converter 110 and analyzer 120. Alternatively, system 100 may comprise an operating system having converter 110 and analyzer 120. Still alternatively, system 100 may be a cloud server.

FIG. 1A illustrates a training system 100A, in accordance with various embodiments. In embodiments, training system 100A may be very similar to system 100 of FIG. 1, with a few variations. For ease of description, only these variations will be described. In embodiments, training system 100 A may be used to train the ANN of system 100 of FIG. 1, namely partially retrained ANN 123. In embodiments, training system 100A may include the same converter 110, with the same components, as does system 100 of FIG. 1. It is noted, however, that malware binary file(s) 101 that are input into training system 100A may be a training set of malware binary files known to contain specific types of malware, which may be used to train the final layers of ANN 123, using re-training module 125.

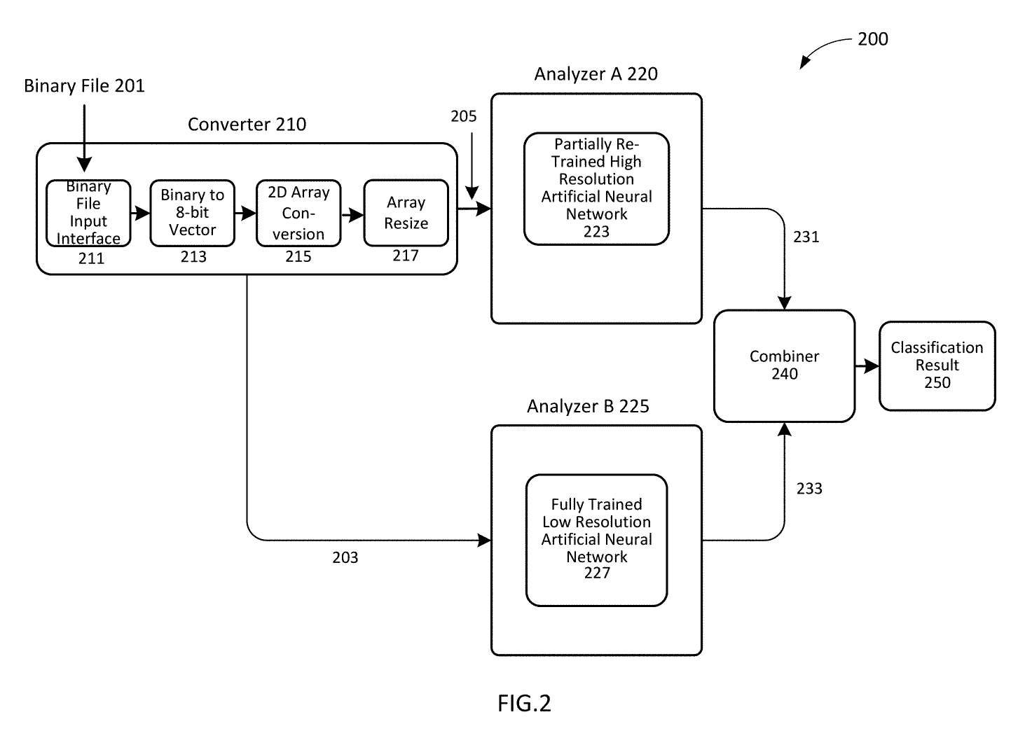

Thus, training system 100A of FIG. 1A, instead of using a fully trained analyzer to process 2D images, may instead include training module 120. Training module 120, as shown, may load a pre-trained ANN 123, that may be partially re-trained by retraining module 125. As shown, in embodiments, retraining module 125 may retrain the last few layers of pre-trained ANN 123 using a set of malware containing binaries converted to 2D images, where the malware containing binaries are input to converter 110, as shown. In other embodiments, training system 1A may be used to fully train all layers of an ANN, such as, for example, low resolution model 205 as shown in FIG. 2, described below.

It is noted that when the 2D images are resized by array resize module 117 to 224 by 224, for example, there are several ANNs that may be utilized as pre-trained ANN 123, and thereby leverage transfer learning in accordance with various embodiments. These ANNs may include, for example, Inception-BN, VGG, or AlexNet, as noted above. In embodiments, the architecture may be kept as the original model, and then the last pooling layer, prior to all of the fully connected layers, towards the end of the neural network architecture, may be identified. Then the parameters and weights prior to the last pooling layer may be kept the same. In embodiments, the parameter names of the last few fully connected layers may be kept the same, but the values may be updated based on training on a specific malware dataset. In embodiments, the training dataset may be partitioned into a training set and a validation set.

Continuing with reference to FIG. 1A, once the last few layers of the pre-trained ANN 123 have been retrained, it remains to decide which epoch of the ANN to select. This is the function of validation and classification module 140.

In embodiments, the parameters of the ANN may be initialized as uniform distribution or Gaussian distribution. Next the learning rates, number of epochs, evaluation metric, momentum, weight decay, stochastic gradient descent as the optimizer and batch size may be set. Then, in embodiments, the model at a k-th epoch may be set as a final model, based on the validation accuracy. It is noted that if the training accuracy increases while the validation accuracy decreases, this will cause overfitting. However, if the training accuracy and validation accuracy are both increasing, this indicates that the model has not yet converged, and may still be trained for better accuracy. In embodiments, when an epoch is reached in which the validation accuracy of the model does not increase, but the validation accuracy has not yet begun to decrease, the model at the corresponding k-th epoch may be selected. This model may then be used for testing, for example as partially re-trained ANN 123, of analyzer 120, in FIG. 1.

An example partially retrained ANN is depicted in FIGS. 4A through 4L. Here a pre-trained ImageNet Inception-BN network was used to store initial weights. These are depicted in FIGS. 4A through 4K. The final layer was then retrained, the output of which is shown in FIG. 4L. Thus, in the example Inception-BN network of FIGS. 4A through 4L, the Inception-BN network was loaded at the 126th iteration, and the weights and architecture for the earlier weights frozen. It is noted that these weights were obtained from training the Inception-BN ANN on the 10 million images from the ImageNet dataset. Then the last fully connected layer and softmax layer, i.e., fully connected layer 410 and softmax layer 420 of FIG. 4L, were retrained on a training set of malware images. In this example, the last layers were retrained using a benchmark dataset containing 9458 types of malware from 25 malware families. These families include, for example, Adialer, Agent, Allaple, and Yuner.

In an alternate example, if a VGG network is chosen as pre-trained ANN 123, then system 100A may freeze the top layers and retrain module 125 may retrain, after max-pooling, the last three fully connected layers and a softmax layer.

FIG. 2 illustrates an alternate system overview, depicting an “ensemble” system 200, in accordance with various embodiments. It is noted that the example system of FIG. 2 is a superset of that of system 100 of FIG. 1. Converter 210 of FIG. 2 is equivalent to converter 110 of FIG. 1, and analyzer A 220 of FIG. 2 is equivalent to analyzer 120 of FIG. 1. Similarly, classification result 250 of FIG. 2 is equivalent to classification result 140 of FIG. 1. As a result, these equivalent elements of system 200 need not be further described.

Continuing with reference to FIG. 2, the additional elements of system 200, not having equivalents in FIG. 1, include analyzer B 225, and ensemble module 240. System 200 of FIG. 2 thus uses two analyzers, analyzer A 220, which includes a partially retrained ANN 223, equivalent to partially retrained ANN 123 of FIG. 1, and a second analyzer, analyzer B 225, which includes a fully trained low resolution ANN 225, which, in embodiments, may be a lower resolution model with a top-to-bottom training scheme on malware binaries. It is here noted that, in embodiments, low resolution ANN 227 may be trained from scratch to recognize malware binaries, or, in alternate embodiments, it may be an ANN that is trained from scratch to recognize malware binaries, but whose architecture may be preserved from existing neural network architectures, such as, for example, a LeNet structure, a CIFAR-10 neural network structure, or, for example, multilayer perceptrons to allow training and testing on different sizes of lower resolution malware images.

In embodiments, because ANN 227 is a lower resolution model, it may accept as inputs smaller 2D images. Thus, in embodiments, converter 210 may output two versions of a resized 2D image, one input to analyzer A through link 205, and the other input to analyzer B through link 203. In embodiments, the resized 2D image input to analyzer B 225 may have, for example, a size in the range from 28 by 28 to 64 by 64. In embodiments, fully trained low resolution ANN 227 may include, for example, a LeNet structure, a CIFAR-10 neural network structure, or, for example, multilayer perceptrons to allow training and testing on different sizes of lower resolution malware images.

In embodiments, each of analyzers A and B, respectively containing high resolution partially retrained ANN 223 and fully trained low resolution ANN 227, may process their respective versions of resized 2D images received from converter 210. These results may then each be input to combiner 240, via links 231 and 233. In embodiments, combiner 240 may produce as output a classification result 250. In embodiments, classification result 250 may provide a probability of whether binary file 201 is, or contains, a malicious application or a benign application. In embodiments, if the result is malicious, combiner 240 may further provide a probability as to which malware family the application belongs to. In embodiments, in generating classification result 250, combiner 240 may ensemble (i.e., combine) the results of each of analyzers A and B.

In embodiments, combiner 240 may have several modes of combining results. For example, it may take a weighted average, average, majority vote, weighted majority vote, or boosting on the models, to combine the results of each of analyzers A and B. It is here noted that boosting is an iterative procedure, which may contain multiple classifiers. The training set used for each of the classifiers may be chosen based on the performance of each classifier. Boosting chooses misclassified training data points more frequently than correctly classified training data. In embodiments, combiner 240 may generally give higher weight to the output of the high resolution model, i.e., ANN 223. It is here noted that in experiments performed using various embodiments, it was observed that the two ANNs 223 and 227 disagreed less than 2% of the time. In embodiments, such disagreement may include whether malware is present in the binary file at all, or, given that malware is present, which type of malware it is. Thus, for example, if ANN 223 achieves a 99% accuracy and ANN 227 achieves a 97% accuracy, in embodiments, there is still room to achieve a higher than 99% accuracy by ensembling the two ANNs. Moreover, if one ANN predicts that an input file is malicious with a 85% probability, and the other ANN predicts that the file is malicious with a 55% probability, in embodiments, using an ensemble may strengthen the probabilities and confidence of prediction.

It is here noted that when the high resolution ANN disagrees with the low resolution ANN and the high resolution one correctly predicts, it may be that the low resolution ANN does not contain as much information as possible as the high resolution ANN. On the other hand, when the two disagree but the low resolution ANN correctly predicts, it may be that the low resolution ANN, due to the training of all of its layers, i.e., from top to bottom, only on malware data (rather than using the transfer learning scheme of ANN 223), may capture and extracts features of the malware dataset more accurately.

In embodiments, higher resolution ANN 223 may be considered to have greater accuracy. Therefore, in embodiments, in the combiner's ensemble process, the higher resolution model may preferably be accorded greater weight. However, in embodiments, lower resolution ANN 227 may also be very useful, as it may help improve overall accuracy of classification result 250. Because, in embodiments, lower resolution ANN 227 is trained on malware data from top to bottom layers, without utilizing other learned knowledge from a different domain, in embodiments, feature extraction by low resolution ANN 227 may help differentiate cases where features of the binary file extracted by high resolution ANN 223 cannot be distinguished.

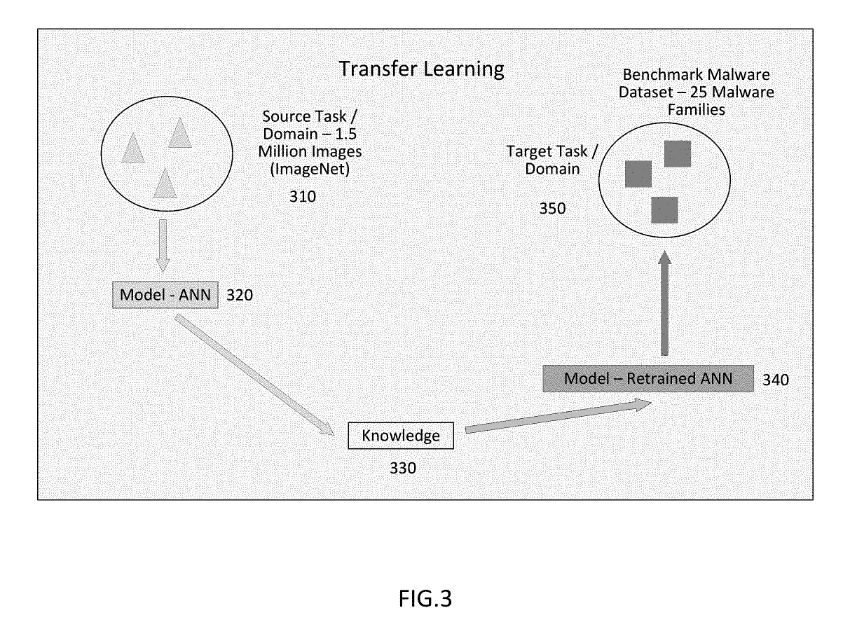

FIG. 3 illustrates transfer learning as used in accordance with various embodiments. Transfer learning involves storing knowledge gained solving one problem and applying it to a different but related problem. It is here noted generally that transfer learning involves the concepts of a domain and a task.

More rigorously, a domain D may consist of a feature space X and a marginal probability distribution P(X) over the feature space, X=x1, . . . xnϵX. Given a domain, D−[X,P(X)], a task T may consist of a label space Y and a conditional probability distribution P(Y|X) that is typically learned from the training data consisting of pairs xiϵX and yiϵY. In embodiments, Y may be the set of all malware family labels.

Given a source domain D_{S}, a corresponding source task T_{S}, as well as a target domain D_{T} and a target task T_{T}, the objective of transfer learning now is to enable us to learn the target conditional probability distribution P(Y_{T}|X_{T}) in with the information gained from D_{S} and T_{S} where D_{S}−D_{T} or T_{S}−T_{T}.

FIG. 3 illustrates the application of these principles to the use of transfer learning in malware detection and classification systems, in accordance with various embodiments. Thus, with reference to FIG. 3, a source domain Dₒ 310 may include 1.5 million images. An ANN 320, such as, for example, Inception-BN, may be trained on source domain 310 for the source task T_{T} of image feature extraction and classification. As a result, it contains knowledge 330 that may be ported to a target domain D_{T} of benchmark malware dataset 350 and a target task T_{T} of malware feature extraction and detection in malware binaries converted to resized multi-dimensional arrays. As shown, this may be accomplished by retraining ANN 320 on target domain D_{T} 350, to obtain retrained ANN 340. In embodiments, one benefit of using transfer learning is the sheer difference in size of the source and target domains. There is generally a limited number of target domain examples, the malware binaries. This number is exponentially smaller than the number of labeled source examples that are available, namely the images in the ImageNet database.

Thus, in the example ANN depicted in FIGS. 4A through 4L, the Inception-network was first trained on the 1.5 million images in ImageNet. Subsequently, using the training system illustrated in FIG. 1A, the last two layers of Inception-network was retrained using, as noted above, a benchmark malware dataset. As noted above, FIGS. 4A through 4K depict the frozen layers of the example Inception-network, and FIG. 4L depicts the retrained last two layers (below, or following, final pooling layer 401), FullyConnected fcl 410 and softmax 420.

In this example, because the pre-trained ANN included 3-channels while the malware training data was one-channel, the resized 2D greyscale images were duplicated twice to convert to three channels of input data.

It is noted that to initialize the re-training of an Inception ANN, first the parameters initially in the layer in FIG. 4L may be uniformly sampled. Then a learning rate, momentum and number of epochs may be set to proceed with the re-training. In the training of the ANN of FIGS. 4A through 4L, the model training scheme converged at the 10th epoch. The following is exemplary pseudocode that may be used, in embodiments, to program such retraining:
load the pre-trained Inception-BN at 126th iteration;
freeze the weights and architecture for earlier weights as seen in FIGS. 4A-4K;
reassign fully connected weight and fully connected bias parameters. Initiate parameter values by randomly sample from uniform distribution;
retrain the network on the fully connected layer;
use validation dataset to determine the model to use, (i.e. model at which epoch).

As noted above, if it is desired to use a VGG ANN for transfer learning, then, in embodiments, a system may freeze the top layers of the VGG ANN and then retrain its last three layers for malware classification.

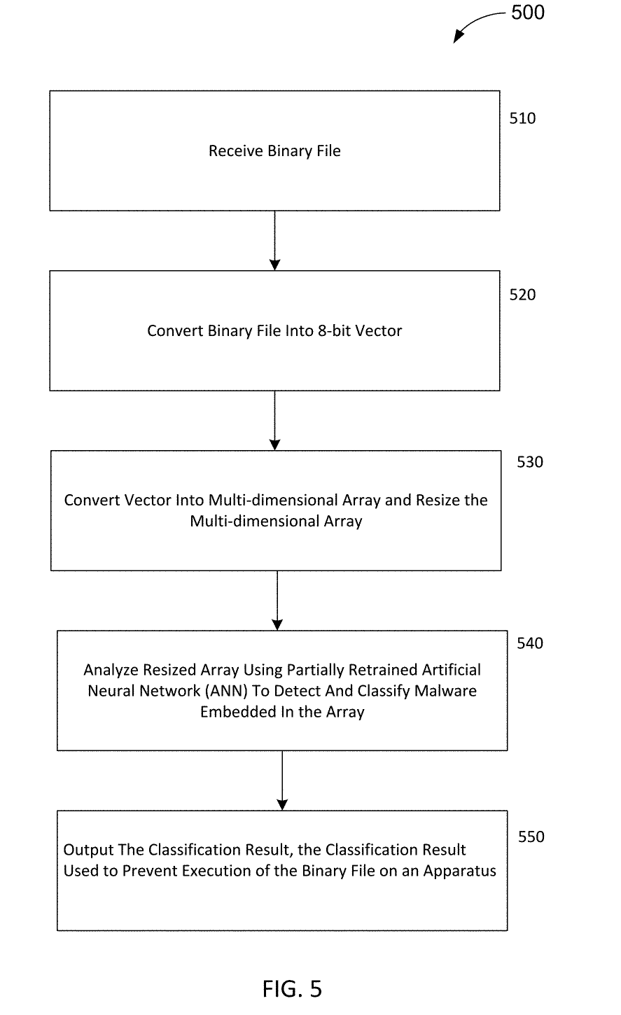

FIG. 5 illustrates an overview of the operational flow of a process for detecting and classifying malware in accordance with various embodiments. With reference to FIG. 5, process 500 may be performed by a system or apparatus according to various embodiments. In embodiments, process 500 may be performed by a system similar to that shown in FIG. 1. Process 500 may include blocks 510 through 550. In alternate embodiments, process 500 may have more or less operations, and some of the operations may be performed in different order.

Process 500 may begin at block 510, where an example system may receive a binary file. The binary file may comprise audio data, textual data, image data, or the like. In general, the binary file is not known to be secure, and may contain malware, which is why it is desirable to scan and classify it before allowing it to be executed any apparatus. From block 510 process 500 may proceed to block 520, where the binary file may be converted into an 8-bit vector. In embodiments, the vector may be of 8-bit unsigned integers. More generally, in embodiments, the vector may map the binary representation of a file to integers between 0 and 255.

From block 520 process 500 may proceed to block 530, where the 8-bit vector may be converted into a multi-dimensional array, and then resized. In embodiments, the multi-dimensional array may be a 2D array, and may be resized to a size of 224 by 224, or 299 by 299, for example. In embodiments, blocks 510 through 530 may be performed by converter 110 depicted in FIG. 1, for example.

From block 530 process 500 may proceed to block 540, where the resized multi-dimensional array may be analyzed using a partially retrained ANN to detect and classify malware embedded in the array. In embodiments, the multi-dimensional array may be a 2D array, and may be resized to a size of 224 by 224, or 299 by 299, for example. In embodiments, the partially retrained ANN may have an input layer, an output layer and a plurality of hidden layers between the input and output layers. In embodiments, block 540 of process 500 may be performed by analyzer 120 depicted in FIG. 1, for example. Finally, from block 540 process 500 may proceed to block 550, where, a classification result may be output, which may be used to prevent execution of the binary file on an apparatus. At block 550, process 500 may terminate.

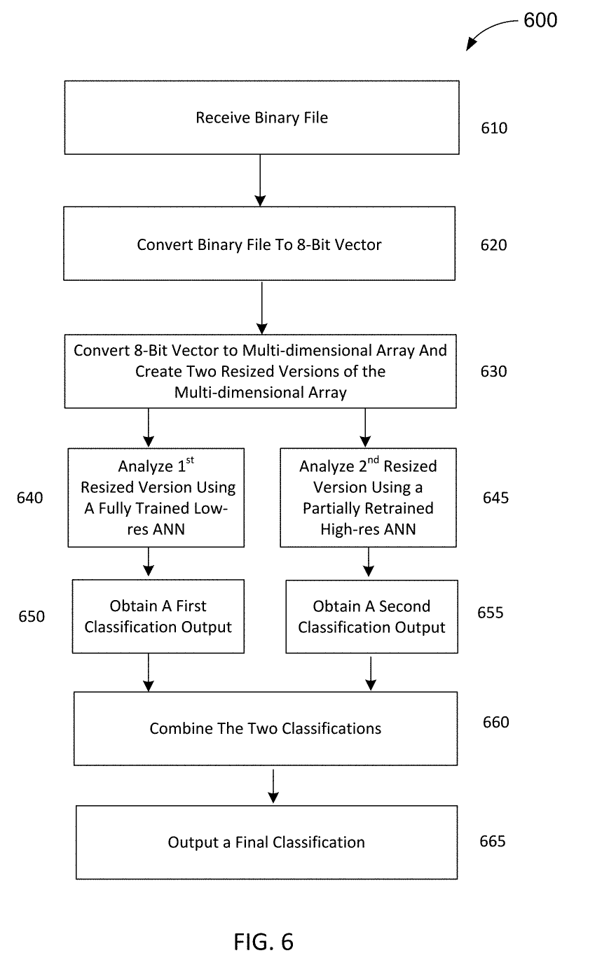

FIG. 6 illustrates an overview of the operational flow of an alternate process 600 for detecting and classifying malware, using an ensemble of two ANNs, in accordance with various embodiments. With reference to FIG. 6, process 600 may be performed by a system or apparatus according to various embodiments. In embodiments, process 600 may be performed by a system similar to that shown in FIG. 2. Process 600 may include blocks 610 through 665. In alternate embodiments, process 600 may have more or less operations, and some of the operations may be performed in different order.

Process 600 may begin at block 610, where an example system may receive a binary file. The binary file may comprise audio data, textual data, image data, or the like. In general, the binary file is not known to be secure, and may contain malware, which is why it is desirable to scan and classify it before allowing it to be executed any apparatus. From block 610 process 600 may proceed to block 620, where the binary file may be converted into an 8-bit vector. In embodiments, the vector may be of 8-bit unsigned integers. More generally, in embodiments, the vector may map the binary representation of a file to integers between 0 and 255.

From block 620 process 600 may proceed to block 630, where the 8-bit vector may be converted into a multi-dimensional array, and then the multi-dimensional array resized into two versions, of different sizes, to use as respective inputs into two separate ANNs. In embodiments, a first version of the resized array may be smaller, for input into a lower resolution ANN, and a second version of the resized array may be larger, for input into a higher resolution ANN. In embodiments, the multi-dimensional array may be a 2D array, and a first resized version of the 2D array may have a size of 224 by 224, or 299 by 299, for example. In embodiments, a second resized version of the 2D array may have a size of between 28 by 28 and 64 by 64, for example. In embodiments, blocks 610 through 630 may be performed by converter 210 as depicted in FIG. 2, for example.

From block 630 process 600 may bifurcate, and may proceed to both block 640 and block 645. At block 640, a first resized version of the multi-dimensional array, i.e., the smaller version, may be analyzed using a fully trained low resolution ANN to detect and classify malware embedded in the array. Similarly, and in parallel, at block 645, a second resized version of the multi-dimensional array, i.e., the larger version, may be analyzed using a partially retrained high resolution ANN to detect and classify malware embedded in the array. In embodiments, the partially retrained ANN may have an input layer, an output layer and a plurality of hidden layers between the input and output layers.

From blocks 640 and 645, process 600 may proceed, respectively, to blocks 650 and 655. At block 650 a first classification output of the binary file may be obtained, from the low resolution ANN, and at block 655 a second classification output of the binary file may be obtained, from the high resolution ANN. In embodiments, blocks 640 and 650 of process 600 may be performed by analyzer B 225 depicted in FIG. 2, for example, and blocks 645 and 655 of process 600 may be performed by analyzer A 223 depicted in FIG. 2, for example. Finally, from blocks 650 and 655, process 600 may converge, and proceed to block 660, where the two classification outputs may be combined. In embodiments, block 660 may be performed by combiner 240 depicted in FIG. 2. In embodiments, the two classification outputs may be combined using various algorithms, such as, for example, weighted average, average, majority vote, weighted majority vote, or boosting on the ANNs.

Finally, from block 660, process 600 may proceed to block 665, where a final classification may be output, which may be used to prevent execution of the binary file on an apparatus. At block 665, process 600 may terminate.

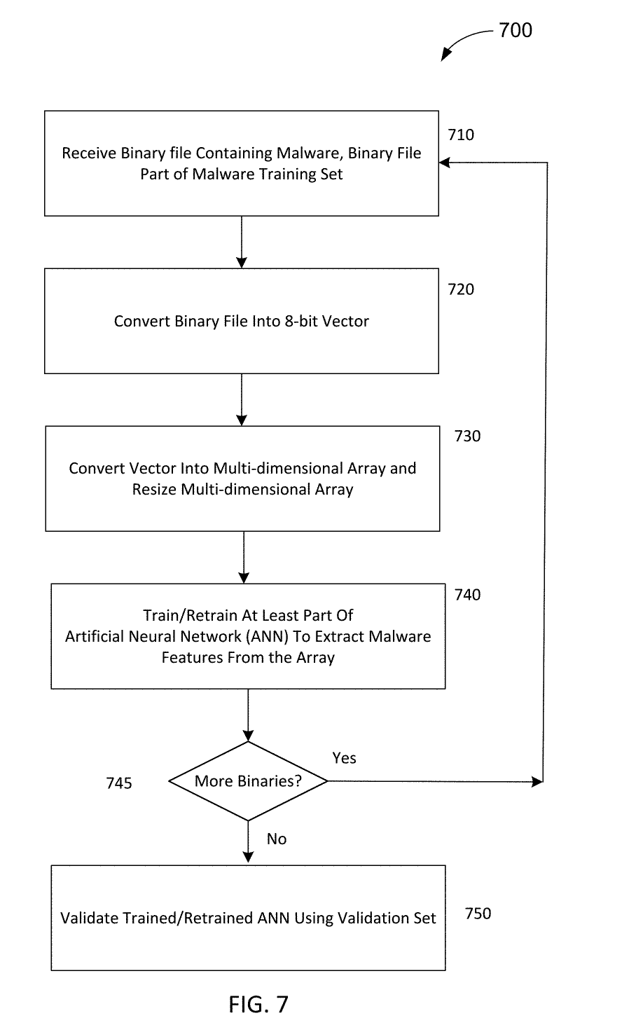

FIG. 7 illustrates an overview of the operational flow of a process 700 for training and validating a malware detection and classification system, in accordance with various embodiments. It is noted that just as system 100 of FIG. 1 is similar to system 100A of FIG. 1A, process 700 is similar to process 500 of FIG. 5, with some variation for the specifics of training.

With reference to FIG. 7, process 700 may be performed by a system or apparatus according to various embodiments. In embodiments, process 700 may be performed by a system similar to that shown in FIG. 1. Process 700 may include blocks 710 through 750. In alternate embodiments, process 700 may have more or less operations, and some of the operations may be performed in different order.

Process 700 may begin at block 710, where an example system may receive a binary file. The binary file may comprise audio data, textual data, image data, or the like. The binary file may contain malware, as part of a malware binary training set that may be used to train an ANN on. From block 710 process 700 may proceed to block 720, where the binary file may be converted into an 8-bit vector. In embodiments, the vector may be of 8-bit unsigned integers. More generally, in embodiments, the vector may map the binary representation of a file to integers between 0 and 255.

From block 720 process 700 may proceed to block 730, where the 8-bit vector may be converted into a multi-dimensional array, and then resized. In embodiments, the multi-dimensional array may be a 2D array, and may be resized to a size of 224 by 224, or 299 by 299, for example. In embodiments, blocks 710 through 730 may be performed by converter 110 depicted in FIG. 1A, for example.

From block 730 process 700 may proceed to block 740, where the resized multi-dimensional array may be used to, train an ANN or, retrain, at least partially, an ANN to extract malware features from the multi-dimensional array. In embodiments, the ANN to be either trained or partially retrained may have an input layer, an output layer and a plurality of hidden layers between the input and output layers. In embodiments, block 740 of process 700 may be performed by training 120 depicted in FIG. 1A, for example. It is noted that blocks 710 through 740 may be repeated for several malware binaries, such as may comprise an entire training set. Thus, process 700 may proceed from block 740 to query block 745, where it may be determined if there are additional malware binaries to train the ANN on. If Yes at query block 745, than process 700 may return to block 710, and repeat the process flow of blocks 710 through 740. However, if the result of query block 745 is No, then process 700 may proceed to block 750, where the trained or retrained ANN (whether partially retrained or fully trained) may be validated using a validation set, which, in embodiments, may also be a set of known malware binaries, but different than the training set. At block 750, process 700 may terminate.

It is here noted that process 700 of FIG. 7 may be used to train either of the ANNs shown in the ensemble system 200, illustrated in FIG. 2. Thus, in the case of partially retrained high-resolution ANN 223, only the last few layers of the ANN will be retrained using process 700. However, the low-resolution ANN 227, which may, in embodiments, be fully trained from scratch, may, using process 700 be trained on a training set of malware binaries. If low-resolution ANN 227 is to be trained from scratch, then at block 740 process 700 may perform the “train” option of block 740. In embodiments, the low-resolution ANN 227 may be fully trained from scratch on a malware dataset, and its architecture newly defined. Or, in embodiments, alternatively, the low-resolution ANN 227 may be fully trained from scratch on a malware dataset, but the architecture of the ANN may be preserved from existing neural network architectures, such as, for example, a LeNet structure, a CIFAR-10 neural network structure, or, for example, multilayer perceptrons to allow training and testing on different sizes of lower resolution malware images. In still alternate embodiments, low-resolution ANN 227 may be partially retrained, and utilize transfer learning, as described above in the case of high-resolution ANN 223.

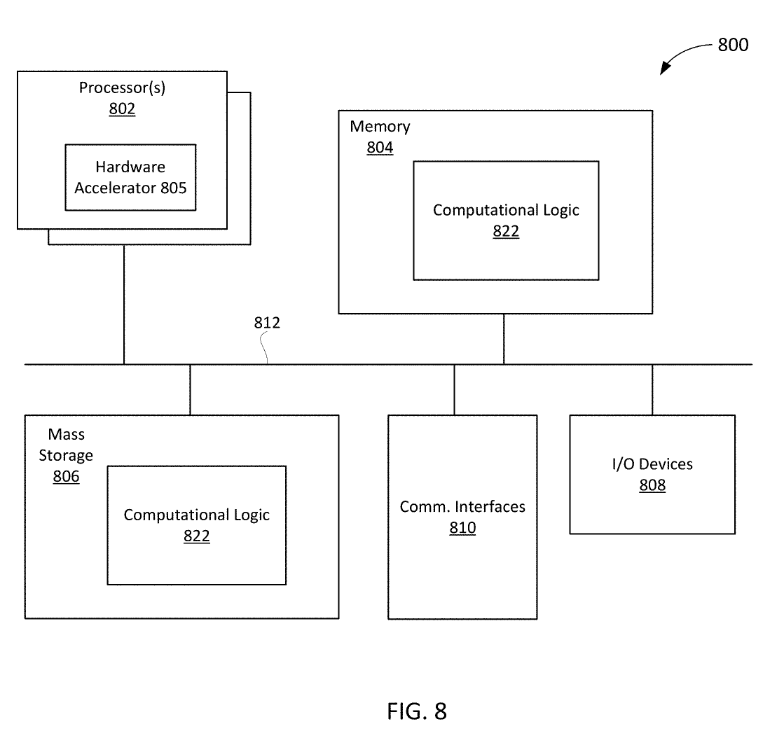

Referring now to FIG. 8 wherein a block diagram of a computer device suitable for practicing the present disclosure, in accordance with various embodiments, is illustrated. As shown, computer device 800 may include one or more processors 802, memory controller 803, and system memory 804. Each processor 802 may include one or more processor cores, and hardware accelerator 805. An example of hardware accelerator 805 may include, but is not limited to, programmed field programmable gate arrays (FPGA). In embodiments, processor 802 may also include a memory controller (not shown). In embodiments, system memory 804 may include any known volatile or non-volatile memory.

Additionally, computer device 800 may include mass storage device(s) 806 (such as solid state drives), input/output device interface 808 (to interface with various input/output devices, such as, mouse, cursor control, display device (including touch sensitive screen), and so forth) and communication interfaces 810 (such as network interface cards, modems and so forth). In embodiments, communication interfaces 810 may support wired or wireless communication, including near field communication. The elements may be coupled to each other via system bus 812, which may represent one or more buses. In the case of multiple buses, they may be bridged by one or more bus bridges (not shown).

Each of these elements may perform its conventional functions known in the art. In particular, system memory 804 and mass storage device(s) 806 may be employed to store a working copy and a permanent copy of the executable code of the programming instructions of an operating system, one or more applications, and/or various software implemented components of converter 110, binary file input interface 111, binary to 8-bit vector conversion 113, 2D array conversion 115, array resize 117 of FIGS. 1 and 1A, analyzer 120, partially retrained ANN 123 of FIG. 1, training 120, retrain 125 and validation and classification 140 of FIG. 1A, converter 210, binary file input interface 211, binary to 8-bit vector conversion 213, 2D array conversion 215, array resize 217, analyzer A 220, partially retrained ANN 223, analyzer B 225, fully trained ANN 227 and combiner 240 of FIG. 2, collectively referred to as computing logic 822. The programming instructions implementing computing logic 822 may comprise assembler instructions supported by processor(s) 802 or high-level languages, such as, for example, C, that can be compiled into such instructions. In embodiments, some of computing logic may be implemented in hardware accelerator 805. In embodiments, part of computational logic 822, e.g., a portion of the computational logic 822 associated with the runtime environment of the compiler may be implemented in hardware accelerator 805.

The permanent copy of the executable code of the programming instructions or the bit streams for configuring hardware accelerator 805 may be placed into permanent mass storage device(s) 806 and/or hardware accelerator 805 in the factory, or in the field, through, for example, a distribution medium (not shown), such as a compact disc (CD), or through communication interface 810 (from a distribution server (not shown)). While for ease of understanding, the compiler and the hardware accelerator that executes the generated code that incorporate the predicate computation teaching of the present disclosure to increase the pipelining and/or parallel execution of nested loops are shown as being located on the same computing device, in alternate embodiments, the compiler and the hardware accelerator may be located on different computing devices.

The number, capability and/or capacity of these elements 810-812 may vary, depending on the intended use of example computer device 800, e.g., whether example computer device 800 is a smartphone, tablet, ultrabook, a laptop, a server, a set-top box, a game console, a camera, and so forth. The constitutions of these elements 810-812 are otherwise known, and accordingly will not be further described.

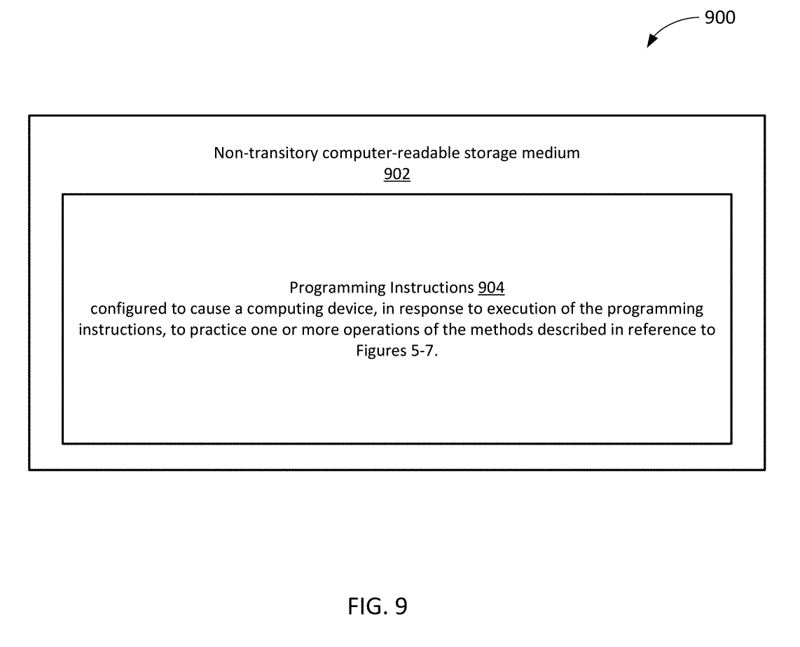

FIG. 9 illustrates an example computer-readable storage medium having instructions configured to implement all (or portion of) software implementations of converter 110, binary file input interface 111, binary to 8-bit vector conversion 113, 2D array conversion 115, array resize 117 of FIGS. 1 and 1A, analyzer 120, partially retrained ANN 123 of FIG. 1, training 120, retrain 125 and 1validation and classification 140 of FIG. 1A, converter 210, binary file input interface 211, binary to 8-bit vector conversion 213, 2D array conversion 215, array resize 217, analyzer A 220, partially retrained ANN 223, analyzer B 225, fully trained ANN 227 and combiner 240 of FIG. 2, and/or practice (aspects of) processes 500 of FIG. 5, 600 of FIGS. 6, and 700 of FIG. 7, earlier described, in accordance with various embodiments. As illustrated, computer-readable storage medium 1002 may include the executable code of a number of programming instructions or bit streams 1004. Executable code of programming instructions (or bit streams) 1004 may be configured to enable a device, e.g., computer device 800, in response to execution of the executable code/programming instructions (or operation of an encoded hardware accelerator 875), to perform (aspects of) process 500 of FIG. 5, process 600 of FIG. 6, and/or 700 of FIG. 7. In alternate embodiments, executable code/programming instructions/bit streams 904 may be disposed on multiple non-transitory computer-readable storage medium 902 instead. In embodiments, computer-readable storage medium 902 may be non-transitory. In still other embodiments, executable code/programming instructions 904 may be encoded in transitory computer readable medium, such as signals.

Referring back to FIG. 8, for one embodiment, at least one of processors 802 may be packaged together with a computer-readable storage medium having some or all of computing logic 822 (in lieu of storing in system memory 804 and/or mass storage device 806) configured to practice all or selected ones of the operations earlier described with reference to FIGS. 5-7. For one embodiment, at least one of processors 802 may be packaged together with a computer-readable storage medium having some or all of computing logic 822 to form a System in Package (SiP). For one embodiment, at least one of processors 802 may be integrated on the same die with a computer-readable storage medium having some or all of computing logic 822. For one embodiment, at least one of processors 802 may be packaged together with a computer-readable storage medium having some or all of computing logic 822 to form a System on Chip (SoC). For at least one embodiment, the SoC may be utilized in, e.g., but not limited to, a hybrid computing tablet/laptop.

Illustrative examples of the technologies disclosed herein are provided below. An embodiment of the technologies may include any one or more, and any combination of, the examples described below.

### EXAMPLES

Example 1 may include an apparatus for computing, comprising: a converter to receive and convert a binary file into a multi-dimensional array, the binary file to be executed on the apparatus or another apparatus; and an analyzer coupled to the converter to: process the multi-dimensional array to detect and classify malware embedded within the multi-dimensional array using at least one partially retrained artificial neural network having an input layer, an output layer and a plurality of hidden layers between the input and output layers; and output a classification result; wherein the classification result is used to prevent execution of the binary file on the apparatus or another apparatus.

Example 2 may include the apparatus of example 1, and/or any other example herein, wherein the multi-dimensional array is a 2D array.

Example 3 may include the apparatus of example 2, and/or any other example herein, wherein the converter is to first convert the binary file to a vector of 8-bit unsigned integers, and then convert the vector to the 2D array.

Example 4 may include the apparatus of example 3, and/or any other example herein, wherein the converter is further to first convert the vector to an internal 2D array, and then resize the internal 2D array prior to the outputting the 2D array.

Example 5 may include the apparatus of example 4, and/or any other example herein, wherein the resized 2D array has a size of one of 224 by 224, or 299 by 299.

Example 6 may include the apparatus of example 1, and/or any other example herein, wherein the at least one partially retrained artificial neural network includes a neural network previously trained to recognize patterns, with the weights of a number of its initial layers frozen, and the weights of a number of its last layers retrained to recognize malware binaries.

Example 7 may include the apparatus of example 6, and/or any other example herein, wherein the artificial neural network is one of an Inception-BN network, Visual Geometry Group (VGG) network or AlexNet network.

Example 8 may include the apparatus of example 6, and/or any other example herein, wherein the artificial neural network is Inception-BN network, with its last layer retrained to classify malware.

Example 9 may include the apparatus of example 6, and/or any other example herein, wherein the artificial neural network is one of Visual Geometry Group (VGG) 16 or VGG 19, with its top layers frozen and its last three layers retrained to classify malware.

Example 10 may include the apparatus of any one of examples 1-9, and/or any other example herein, comprising a malware detector having the converter and the analyzer.

Example 11 may include the apparatus of any one of claims 1-9, and/or any other example herein, comprising an operating system having the converter and the analyzer.

Example 12 may include the apparatus of any one of claims 1-9, and/or any other example herein, wherein the apparatus is a cloud server.

Example 13 may include an apparatus for computing, comprising: a converter to receive and convert a binary file into two multi-dimensional arrays, the binary file to be executed on the apparatus or another apparatus; a first analyzer and a second analyzer, each coupled to the converter, and each to: process one of the multi-dimensional arrays to detect and classify malware embedded within the multi-dimensional array using one of a trained, retrained or partially retrained ANN having an input layer, an output layer and a plurality of hidden layers between the input and output layers; and output a classification result, the classification result used to prevent execution of the binary file on the apparatus or another apparatus; and a combiner, coupled to each of the first and second analyzers, to process the classification results and output a combined classification result.

Example 14 may include the apparatus of example 13, and/or any other example herein, wherein the multi-dimensional arrays are 2D arrays.

Example 15 may include the apparatus of example 14, and/or any other example herein, wherein the converter is to first convert the binary file to a vector of 8-bit unsigned integers, and then convert the vector to the 2D arrays.

Example 16 may include the apparatus of example 15, and/or any other example herein, wherein the converter is further to first convert the vector to an internal 2D array, and then resize the internal 2D array to obtain the 2D arrays.

Example 17 may include the apparatus of example 16, and/or any other example herein, wherein one of the resized 2D arrays has a size of either 224 by 224, or 299 by 299.

Example 18 may include the apparatus of example 16, and/or any other example herein, wherein one of the resized 2D arrays has a size in the range from 28 by 28 to 64 by 64.

Example 19 may include the apparatus of example 13, and/or any other example herein, wherein the ANN of the first analyzer includes a neural network previously trained to recognize patterns, with the weights of a number of its initial layers frozen, and the weights of a number of its last layers retrained to recognize malware binaries.

Example 20 may include the apparatus of example 13, and/or any other example herein, wherein the ANN of the second analyzer is fully trained on a set of malware images, and its architecture newly defined.

Example 21 may include the apparatus of example 13, and/or any other example herein, wherein the ANN of the second analyzer is fully trained on a set of malware images, but its architecture preserves one of: a LeNet structure, a CIFAR-10 neural network structure or multilayer perceptrons.

Example 22 may include one or more non-transitory computer-readable storage media comprising a plurality of instructions that in response to being executed cause a computing device to: receive and convert a binary file into a multi-dimensional array, the binary file to be executed on the computing device or another computing device; process the multi-dimensional array to detect and classify malware embedded within the multi-dimensional array using at least one partially retrained ANN having an input layer, an output layer and a plurality of hidden layers between the input and output layers; and output a classification result, wherein the classification result is used to prevent execution of the binary file on the apparatus or another apparatus.

Example 23 may include the one or more non-transitory computer-readable storage media of example 22, and/or any other example herein, wherein the multi-dimensional array is a 2D array.

Example 24 may include the one or more non-transitory computer-readable storage media of example 23, and/or any other example herein, wherein convert the binary file into a multi-dimensional array includes first convert the binary file to a vector of 8-bit unsigned integers, then convert the vector to an internal 2D array, and then resize the internal 2D array to the input 2D array.

Example 25 may include the one or more non-transitory computer-readable storage media of example 24, and/or any other example herein, wherein the resized 2D array has a size of one of 224 by 224, or 299 by 299.

Example 26 may include the one or more non-transitory computer-readable storage media of example 22, and/or any other example herein, wherein the at least one partially retrained ANN includes a neural network previously trained to recognize patterns, with the weights of a number of its initial layers frozen, and the weights of a number of its last layers retrained to recognize malware binaries.

Example 27 may include the one or more non-transitory computer-readable storage media of example 22, and/or any other example herein, wherein the ANN is one of Inception-BN, Visual Geometry Group (VGG) 16, VGG 19, or AlexNet.

Example 28 may include the one or more non-transitory computer-readable storage media of example 27, and/or any other example herein, wherein the ANN is Inception-BN network, with its last layer retrained to classify malware.

Example 29 may include the one or more non-transitory computer-readable storage media of example 27, and/or any other example herein, wherein the ANN is one of VGG 16 or VGG 19, with its top layers frozen and its last three layers retrained to classify malware.

Example 30 may include the one or more non-transitory computer-readable storage media of any one of examples 22-29, and/or any other example herein, wherein the computing device is a malware detector.

Example 31 may include the one or more non-transitory computer-readable storage media of any one of examples 22-29, and/or any other example herein, provided in, or as part of, an operating system.

Example 32 may include the one or more non-transitory computer-readable storage media of any one of examples 22-29, and/or any other example herein, wherein the computing device is a cloud server.

Example 33 may include a method of detecting malware in binary files, comprising: receiving and converting a binary file into a multi-dimensional array, the binary file to be executed on one or more apparatuses; and processing the multi-dimensional array to detect and classify malware embedded within the multi-dimensional array using at least one partially retrained ANN having an input layer, an output layer and a plurality of hidden layers between the input and output layers; and outputting a classification result; wherein the classification result is used to prevent execution of the binary file on one or more apparatuses.

Example 34 may include the method of example 33, and/or any other example herein, further comprising: converting the binary file into an additional multi-dimensional array, the additional multi-dimensional array smaller than the multi-dimensional array; processing the additional multi-dimensional array to classify malware embedded within the additional multi-dimensional array using a second trained ANN having an input layer, an output layer and a plurality of hidden layers between the input and output layers to obtain a second classification result; combining the first classification result and the second classification result into a final classification result; and outputting the final classification result to a user.

Example 35 may include the method of example 33, and/or any other example herein, wherein the multi-dimensional array is a 2D array.

Example 36 may include the method of example 35, and/or any other example herein, wherein the converter is to first convert the binary file to a vector of 8-bit unsigned integers, and then convert the vector to the 2D array.

Example 37 may include the method of example 36, and/or any other example herein, wherein the converter is further to first convert the vector to an internal 2D array, and then resize the internal 2D array prior to the outputting the 2D array.

Example 38 may include the method of example 37, and/or any other example herein, wherein the resized 2D array has a size of one of 224 by 224, or 299 by 299.

Example 39 may include the method of example 33, and/or any other example herein, wherein the at least one partially retrained ANN includes a neural network previously trained to recognize patterns, with the weights of a number of its initial layers frozen, and the weights of a number of its last layers retrained to recognize malware binaries.

Example 40 may include the method of example 39, and/or any other example herein, wherein the ANN is one of an Inception-BN network, Visual Geometry Group (VGG) network or AlexNet network.

Example 41 may include the method of example 39, and/or any other example herein, wherein the ANN is Inception-BN network, with its last layer retrained to classify malware.

Example 42 may include the method of example 39, and/or any other example herein, wherein the ANN is one of Visual Geometry Group (VGG) 16 or VGG 19, with its top layers frozen and its last three layers retrained to classify malware.

Example 43 may include the method of any one of examples 33-42, and/or any other example herein, performed by a malware detector.

Example 44 may include the method of any one of examples 33-42, and/or any other example herein, performed by an operating system.

Example 45 may include the method of any one of examples 33-42, and/or any other example herein, performed by a cloud server.

Example 46 may include one or more non-transitory computer-readable storage media comprising a plurality of instructions that in response to being executed cause a computing device to perform the method of any one of examples 33-42.

Example 47 may include an apparatus for computing, comprising: means to receive and convert a binary file into a multi-dimensional array, the binary file to be executed on the computing device or another computing device; means to process the multi-dimensional array to detect and classify malware embedded within the multi-dimensional array using at least one partially retrained ANN having an input layer, an output layer and a plurality of hidden layers between the input and output layers; and means to output a classification result, wherein the classification result is used to prevent execution of the binary file on the apparatus or another apparatus.

Example 48 may include the apparatus for computing of example 47, and/or any other example herein, wherein the multi-dimensional array is a 2D array.

Example 49 may include the apparatus for computing of example 48, and/or any other example herein, wherein the means to convert the binary file into a multi-dimensional array includes means to first convert the binary file to a vector of 8-bit unsigned integers, means to convert the vector to an internal 2D array, and means to resize the internal 2D array to the input 2D array.

Example 50 may include the apparatus for computing of example 49, and/or any other example herein, wherein the resized 2D array has a size of one of 224 by 224, or 299 by 299.

Example 51 may include the apparatus for computing of example 47, and/or any other example herein, wherein the at least one partially retrained ANN includes a neural network previously trained to recognize patterns, with the weights of a number of its initial layers frozen, and the weights of a number of its last layers retrained to recognize malware binaries.

Example 52 may include the apparatus for computing of example 47, and/or any other example herein, wherein the ANN is one of Inception-BN, Visual Geometry Group (VGG) 16, VGG 19, or AlexNet.

Example 53 may include the apparatus for computing of example 47, and/or any other example herein, wherein the ANN is Inception-BN network, with its last layer retrained to classify malware.

Example 54 may include the apparatus for computing of example 52, and/or any other example herein, wherein the ANN is one of VGG 16 or VGG 19, with its top layers frozen and its last three layers retrained to classify malware.

Example 55 may include the apparatus for computing of any one of examples 47-54, and/or any other example herein, wherein the apparatus for computing is, or is part of, a malware detector.

Example 56 may include the apparatus for computing of any one of examples 47-54, and/or any other example herein, wherein the apparatus for computing is a cloud server.

Example 57 may include an apparatus for computing, comprising: means to receive and convert a binary file into two multi-dimensional arrays, the binary file to be executed on the apparatus or another apparatus; a first means to analyze and a second means to analyze, each coupled to the means to receive and convert, and each to: process one of the multi-dimensional arrays to detect and classify malware embedded within the multi-dimensional array using one of a trained, retrained or partially retrained ANN having an input layer, an output layer and a plurality of hidden layers between the input and output layers; and output a classification result, the classification result used to prevent execution of the binary file on the apparatus or another apparatus; and a means to combine, coupled to each of the first and second analyzers, to process the classification results and output a combined classification result.

Example 58 may include the apparatus for computing of example 57, and/or any other example herein, wherein the multi-dimensional arrays are 2D arrays.

Example 59 may include the apparatus for computing of example 58, and/or any other example herein, wherein the means to convert is to first convert the binary file to a vector of 8-bit unsigned integers, and then convert the vector to the 2D arrays.

Example 60 may include the apparatus for computing of example 59, and/or any other example herein, wherein the means to convert is further to first convert the vector to an internal 2D array, and further comprising a means to resize the internal 2D array to obtain the 2D arrays.

Example 61 may include the apparatus for computing of example 60, and/or any other example herein, wherein one of the resized 2D arrays has a size of either 224 by 224, or 299 by 299.

Example 62 may include the apparatus for computing of example 60 wherein one of the resized 2D arrays has a size in the range from 28 by 28 to 64 by 64.

Example 63 may include the apparatus for computing of example 57, and/or any other example herein, wherein the ANN of the first means to analyze includes a neural network previously trained to recognize patterns, with the weights of a number of its initial layers frozen, and the weights of a number of its last layers retrained to recognize malware binaries.

Example 64 may include the apparatus for computing of example 63, and/or any other example herein, wherein the ANN of the first means to analyze processes a 2D array that has a size of either 224 by 224, or 299 by 299.

Example 65 may include the apparatus for computing of example 63, and/or any other example herein, wherein the ANN of the second means to analyze processes a 2D array that has a size in the range from 28 by 28 to 64 by 64.

Example 66 may include the apparatus for computing of example 57, and/or any other example herein, wherein the ANN of the second means to analyze is fully trained on a set of malware images, and its architecture newly defined.

Example 67 may include the apparatus for computing of example 57, and/or any other example herein, wherein the ANN of the second means to analyze is fully trained on a set of malware images, but its architecture preserves one of: a LeNet structure, a CIFAR-10 neural network structure or multilayer perceptrons.

Example 68 may include the apparatus for computing of example 57, and/or any other example herein, wherein the means to combine outputs the combined classification result based on at least one of: a weighted average, an average, a majority vote, a weighted majority vote, or boosting on the ANNs of the first and second means to analyze, to combine the results of the first means to analyze and the second means to analyze.

Example 69 may include the apparatus for computing of example 57, and/or any other example herein, wherein the means to combine gives higher weight to the output of the ANN of the first means to analyze.

What is claimed is:

1. An apparatus for computing, comprising:
a converter to receive and convert a binary file into a multi-dimensional array, the binary file to be executed on the apparatus or another apparatus; and
an analyzer coupled to the converter to:
process the multi-dimensional array to detect and classify malware embedded within the multi-dimensional array using at least one partially retrained artificial neural network (ANN) having an input layer, an output layer and a plurality of hidden layers between the input and output layers; and
output a classification result;
wherein the classification result is used to prevent execution of the binary file on the apparatus or another apparatus.

2. The apparatus of claim 1, wherein the multi-dimensional array is a 2D array.

3. The apparatus of claim 2, wherein the converter is to first convert the binary file to a vector of 8-bit unsigned integers, and then convert the vector to the 2D array.

4. The apparatus of claim 3, wherein the converter is further to first convert the vector to an internal 2D array, and then resize the internal 2D array prior to the outputting the 2D array.

5. The apparatus of claim 4, wherein the resized 2D array has a size of one of 224 by 224, or 299 by 299.

6. The apparatus of claim 1, wherein the at least one partially retrained ANN includes a neural network previously trained to recognize patterns, with the weights of a number of its initial layers frozen, and the weights of a number of its last layers retrained to recognize malware binaries.

7. The apparatus of claim 6, wherein the ANN is one of an Inception-BN network, Visual Geometry Group (VGG) network or AlexNet network.

8. The apparatus of claim 6, wherein the ANN is Inception-BN network, with its last layer retrained to classify malware.

9. The apparatus of claim 6, wherein the ANN is one of Visual Geometry Group (VGG) 16 or VGG 19, with its top layers frozen and its last three layers retrained to classify malware.

10. The apparatus of claim 1, comprising a malware detector having the converter and the analyzer.

11. The apparatus of claim 1, comprising an operating system having the converter and the analyzer.

12. The apparatus of claim 1, wherein the apparatus is a cloud server.

13. An apparatus for computing, comprising:
a converter to receive and convert a binary file into two multi-dimensional arrays, the binary file to be executed on the apparatus or another apparatus;
a first analyzer and a second analyzer, each coupled to the converter, and each to:
process one of the multi-dimensional arrays to detect and classify malware embedded within the multi-dimensional array using one of a trained, retrained or partially retrained ANN having an input layer, an output layer and a plurality of hidden layers between the input and output layers; and
output a classification result, the classification result used to prevent execution of the binary file on the apparatus or another apparatus;
and a combiner, coupled to each of the first and second analyzers, to process the classification results and output a combined classification result.

14. The apparatus of claim 13, wherein the multi-dimensional arrays are 2D arrays.

15. The apparatus of claim 14, wherein the converter is to first convert the binary file to a vector of 8-bit unsigned integers, and then convert the vector to the 2D arrays.

16. The apparatus of claim 15, wherein the converter is further to first convert the vector to an internal 2D array, and then resize the internal 2D array to obtain the 2D arrays.

17. The apparatus of claim 13, wherein the ANN of the first analyzer includes a neural network previously trained to recognize patterns, with the weights of a number of its initial layers frozen, and the weights of a number of its last layers retrained to recognize malware binaries.

18. The apparatus of claim 13, wherein the ANN of the second analyzer is fully trained on a set of malware images.

19. One or more non-transitory computer-readable storage media comprising a plurality of instructions that in response to being executed cause a computing device to:
receive and convert a binary file into a multi-dimensional array, the binary file to be executed on the computing device or another computing device;
process the multi-dimensional array to detect and classify malware embedded within the multi-dimensional array using at least one partially retrained ANN having an input layer,
an output layer and a plurality of hidden layers between the input and output layers; and output a classification result,
wherein the classification result is used to prevent execution of the binary file on the apparatus or another apparatus.

20. The one or more non-transitory computer-readable storage media of claim 18, wherein the multi-dimensional array is a 2D array.

21. The one or more non-transitory computer-readable storage media of claim 19, wherein convert the binary file into a multi-dimensional array includes first converting the binary file to a vector of 8-bit unsigned integers, then converting the vector to an internal 2D array, and then resizing the internal 2D array to the input 2D array.

22. The one or more non-transitory computer-readable storage media of claim 18, wherein the at least one partially retrained ANN includes a neural network previously trained to recognize patterns, with the weights of a number of its initial layers frozen, and the weights of a number of its last layers retrained to recognize malware binaries.

23. The one or more non-transitory computer-readable storage media of claim 18, wherein the ANN is one of Inception-BN, VGG 16, VGG 19, or AlexNet.

24. A method of detecting malware in binary files, comprising:
receiving and converting a binary file into a multi-dimensional array, the binary file to be executed on one or more apparatuses; and
processing the multi-dimensional array to detect and classify malware embedded within the multi-dimensional array using at least one partially retrained ANN having an input layer, an output layer and a plurality of hidden layers between the input and output layers; and
outputting a classification result;
wherein the classification result is used to prevent execution of the binary file on one or more apparatuses.

25. The method of claim 24, further comprising:
converting the binary file into an additional multi-dimensional array, the additional multi-dimensional array smaller than the multi-dimensional array;
processing the additional multi-dimensional array to classify malware embedded within the additional multi-dimensional array using a second retrained ANN having an input layer, an output layer and a plurality of hidden layers between the input and output layers to obtain a second classification result;
combining the first classification result and the second classification result into a final classification result; and outputting the final classification result to a user.
